(19) United States
(12) Patent Application Publication
(10) Pub. No.: US 2009/0218553 A1
(43) Pub. Date: Sep. 3, 2009

(54) Electromagnetic Wave Absorption Material for Thermoforming

(75) Inventors: Shiyuuichi Kimura, Shizuoka (JP); Makoto Egashira, Nagasaki (JP); Kiyoshi Yagi, Shizuoka (JP); Takayuki Katou, Shizuoka (JP)

Correspondence Address: EDWARDS ANGELL PALMER & DODGE LLP, P.O. BOX 55874, BOSTON, MA, 02205, US

(73) Assignees: Yazaki Corporation, Minato-ku, TOKYO (JP); Nagasaki University National University Corporatio, Nagasaki-shi, NAGASAKI (JP)

(21) Appl. No.: 11/992,476

(22) PCT Filed: Sep. 25, 2006
(86) PCT No.: PCT/JP2006/319624

§ 371 Date: Mar. 20, 2009

(30) Foreign Application Priority Data
Sep. 26, 2005 (JP) 2005-278582

(51) Int. Cl. F21V 9/00

(52) U.S. Cl. 252/582

(57) ABSTRACT

The present invention is to provide an electromagnetic wave absorption (EWA) material for thermoforming having a good formability and high EWA performance. The EWA material for thermoforming contains a EWA particle covered with a thermoplastic resin layer.

### TECHNICAL FIELD

The present invention relates to an electromagnetic wave absorption (EWA) material for thermoforming to form a molded EWA body having high EWA performance and adapted to electromagnetic shielding.

### RELATED ART

Recent development of communication system such as PHS, mobile telephone and wireless LAN makes office work and daily life convenient. However, it has been realized that the electromagnetic wave generated from the electronic devices causes malfunction of electronic apparatuses and devices, and adverse effect to human body.

In ITS (Intelligent Transport System), a cruise control utilizing GPS technique combined with a car navigation system, several radars, and sensors frequently transmits and receives the electromagnetic wave. There is concern that the electromagnetic wave affects in-vehicle electronic devices such as an electronic control apparatus of an engine.

In order to solve the problem, it is essential to establish a system for not emitting the electromagnetic wave from the electronic devices and not receiving the electromagnetic wave from outside. Application of an electromagnetic wave shielding material to building, room, vehicle body, apparatus housing, electronic device is capable of shielding an unwanted electromagnetic wave.

For example, JP, 2003-273568, A discloses an encapsulated type EWA material.

The EWA material of JP, 2003-273568, A is formed with a mixture of an epoxy resin so that a molded EWA body does not have a uniform composition and high EWA performance.

### DISCLOSURE OF THE INVENTION

According to a first aspect of the present invention, we provide an electromagnetic wave absorption (EWA) material for thermoforming capable of being formed easily, having a uniform characteristic, high EWA performance even at thin molded body.

The performance of the EWA material for thermoforming of the present invention is well described with a result of simulation so that a design of product is easy and a test product is considerably reduced.

An EWA material for thermoforming includes an EWA particle and a thermoplastic resin layer covering the EWA particle.

Preferably, the EWA particle is adhered at a surface thereof with a thermoplastic resin particle, which has a diameter smaller than that of the EWA particle, and heat treated at a temperature above a glass transition temperature of the thermoplastic resin.

Preferably, the EWA particle is hydrophobized and added to a polymerizing composition, and the resulting particle is suspended in an aqueous liquid for polymerization reaction.

Preferably, the EWA particle is hydrophobized with a hydrophobizing finishing agent.

Preferably, a diameter of the suspended particle is adjusted during suspension.

Preferably, the diameter of the suspended particle is adjusted when the resulting particle is poured into the aqueous liquid.

Preferably, the polymerizing composition is poured or sprayed onto an aggregate of the EWA particles while the aggregate is stirred.

Preferably, a molded EWA body with a thickness of at most 5 mm has a reflection loss peak in the frequency of 1.7-13 GHz and the minimum reflection loss of below −20 dB along a direction of the thickness.

Preferably, the molded EWA body with the thickness of at most 5 mm has the reflection loss peak in the frequency of 1.7-3 GHz and/or 6-13 GHz and the minimum reflection loss of below −30 dB along the direction of the thickness.

Preferably, an intermediate EWA body is formed with the EWA material for thermoforming.

Preferably, a product has the molded EWA body formed with the EWA material for thermoforming.

### BRIEF DESCRIPTION OF THE DRAWINGS

FIG. 1 illustrates an apparatus utilized for a third physicochemical method;

FIG. 2A is a SEM image of an EWA material for thermoforming manufactured with a first physical method (hybridization) prior to heat treatment;

FIG. 2B is a SEM image of the EWA material for thermoforming after heat treatment;

FIG. 3 shows minimum reflection loss with respect to thickness of molded EWA bodies formed with the EWA material for thermoforming (the volume ratio of carbonyl iron to PMMA is 50:50) of the present invention;

FIG. 4 shows minimum reflection loss with respect to thickness of molded EWA bodies formed with the EWA material for thermoforming (the volume ratio of EWA particles, which contains carbonyl iron and ferrite with the ratio of 1:1 by volume, to PMMA is 50:50) of the present invention;

FIG. 5 shows spectra of reflection loss with respect to frequency of the molded EWA bodies formed with the EWA material for thermoforming (the volume ratio of carbonyl iron to PMMA is 50:50) of the present invention;

FIG. 6 shows spectra of reflection loss with respect to frequency of the molded EWA bodies formed with the EWA material for thermoforming (the volume ratio of EWA particles, which contains carbonyl iron and ferrite with the ratio of 1:1 by volume, to PMMA is 50:50) of the present invention;

FIG. 7A is a SEM image of a surface of the molded EWA body of the present invention; and

FIG. 7B is a SEM image of a fracture surface of the molded EWA body of the present invention.

### BEST MODE FOR CARRYING OUT THE INVENTION

An electromagnetic wave absorption (EWA) particle of the present invention is utilized from known particles such as carbonyl iron, ferrite, and carbon black. The ferrite includes Mn—Zn ferrite, Ni—Zn ferrite, Ni—Zn—Cu ferrite, Cu—Zn ferrite, Mg—Mn ferrite, Cu—Mg—Mn ferrite, Nd—Fe—B ferrite. Preferably, the EWA particle has a similar grain size but may have an irregular size. The grain size of the EWA particle varies with electromagnetic wave frequency for achieving high EWA performance. The grain size is 0.5-200 μm for the wave frequency of 1.7 GHz-13 GHz and more preferably 1-20 μm.

An EWA material for thermoforming of the present invention is formed by covering the EWA particle with a thermoplastic rein layer. A molded EWA body formed from the EWA material for thermoforming has the EWA particles distributing uniformly in the body. EWA performances of molded EWA bodies are well described with simulation so that a test production is not necessary and the cost is reduced. Even a plate is fabricated from the molded EWA body, the plate has a uniform EWA performance.

Distances between the EWA particles can be controlled by adjusting a thickness of the thermoplastic resin, namely a content thereof, covering the EWA particles. The adjustment of the distance and the uniform distribution of the particles of the molded EWA body provide a high EWA performance. The molded EWA body having a thickness of at most 5 mm distinctly absorbs the electromagnetic wave of frequency 1.7-13 GHz.

A volume fraction of the EWA particles in the EWA material for thermoforming can be freely controlled. As far as the volume fraction of the EWA particles is not more than 90%, the molded EWA body having high strength can be easily formed. Accordingly, material constants, such as complex permittivity and permeability, of the molded EWA body are easily adjusted with a wide range. There is no prior art of the EWA material for thermoforming having a high volume fraction of the EWA particles.

The EWA material for thermoforming of the present invention is formed by covering the metal particles with the thermoplastic resin layer so that the EWA material for thermoforming is formed similarly to the usual thermoplastic resin. Although a desired EWA body is thermoformed directly from the EWA material for thermoforming, an intermediate EWA body, such as pellets, formed with extrusion molding can also be utilized for forming the EWA body.

General molding methods of thermoplastic resin can be adapted to the EWA material for thermoforming. Injection molding, extrusion molding such as forming of a shield layer of an electric wire, blow molding, compression molding, reaction molding, roll sheet molding, and calendar molding are possible. Vacuum molding is also possible for manufacturing film or sheet of the EWA material.

The EWA material for thermoforming of the present invention provides the molded EWA body having insulation property, the high volume fraction of 90% without a binder such as polyethylene, and high EWA performance at the frequency range of 1.7-13 GHz. The EWA particles are distributed uniformly in the molded EWA body so that the molded body has outstanding mechanical properties such as tensile and bending strengths even though the volume fraction of the EWA particles is high.

As described above, the compounding ratio of EWA particles to the resin is adjusted at the manufacturing of the EWA material for thermoforming of the present invention. The thermoplastic resin utilized or a thermoplastic resin compatible with the utilized resin can be added and mixed with the EWA material for thermoforming, which contains a high volume fraction of the EWA particles, to obtain an EWA material for thermoforming containing a desired content of the resin. The latter method, however, does not provide the uniform distribution of the EWA particles so that the former method is preferable to adjust the content of the resin.

The method of manufacturing the EWA material for thermoforming of the present invention is generally a physical method and a physicochemical method. Each method is described below. The method of the present invention provides a molded EWA body having high volume fraction of the EWA particles, an insulation property, and high EWA performance at the frequency range of 1.7-13 GHz. The molded EWA body has the high volume fraction of the EWA particles and the uniform distribution thereof so that the EWA performance of the molded EWA body is well estimated with simulation. The material constants, such as complex permittivity and permeability, are also well simulated.

Physical Method:

Thermoplastic resin particles having a diameter smaller than that of the EWA particles are adhered to the surfaces of the EWA particles and the resulting particles are heated up to a temperature above the glass transition temperature of the thermoplastic resin to form an EWA material for thermoforming.

Hybridization method and mechanofusion method are utilized for adhering the thermoplastic resin particles onto the surfaces of the EWA particles.

The hybridization method utilizes an apparatus (for example, HYBRIDIZER of NARA MACHINERY CO., LTD.) for modifying surface property of particles and combining each other in a dry type with high speed airflow.

Core particles each are covered with sub-particles by means of a mixing dispersion function of an ordered mixture apparatus. The ordered mixture is loaded into a hybridizer to a specified amount. The hybridizer provides impactive force of mechanothermal energy to the particles dispersing in a chamber to fix the sub-particles or form a layer in a short time of 1-10 min. The particles treated are rapidly collected with a collector.

A technique of mechanofusion is developed by HOSOKAWAMICRON CORPORATION. The mechnofusion provides mechanical energy to a number of different particles to adhere each other with the mechanochemical reaction.

Employing these methods, the surfaces of the EWA particles are adhered with the thermoplastic resin particles having a diameter smaller than that of the EWA particles. The covered EWA particles are heat treated at above or near a glass transition temperature of the thermoplastic resin. The heat treatment forms a uniform thickness of the thermoplastic resin layer around each EWA particle. This heat treatment provides a prominent insulation to the covered EWA particles without a thermoset resin, which is usually required for attaining insulation. The thermoset resin is hard to handle in a manufacturing process. Hence, the manufacturing process becomes easy. The EWA material for thermoforming of the present invention utilizes only one kind of resin so that a productivity is improved and a manufacturing cost is reduced. The good coincidence of the EWA performance of the molded EWA body with the simulation omits work and cost of the trial product.

Since the insulation thermoplastic resin covers the EWA particle, the EWA material for thermoforming and molded EWA body of the present invention have material constants, such as complex permittivity and permeability, capable of having high EWA performance at 1.7-13 GHz. The conventional EWA material can not perform EWA at this frequency range.

Thermoplastic resins utilized for the physical method are polyethylene, polypropylene, methacrylic resin, ethylene vinyl acetate (EVA) resin, polystyrene, acrylonitrile styrene (AS) resin, acrylonitrile butadiene styrene copolymer (ABS resin), vinyl chloride resin, methyl methacrylate (MMA) styrene copolymer, polyamide, polycarbonate, polyacetal, polyvinyl alcohol, vinylidene chloride resin, polyester, polyphenylene ether, polyphenylene sulfide, polyether ether ketone, polyallyl ether ketone, polyamide-imide, polyimide, polyetherimide, polysulphone, polyethersulfone, fluorine resin, polyurethane, ionomer, ethylene vinylalcohol (EVOH) resin, chlorinated polyethylene, polydicyclopentadiene, methyl pentene resin, polybutylene, polyacrylonitrile, cellulose resin. Copolymers containing any thermoplastic resins described above are also utilized.

The heat treatment is carried out at a temperature above the glass transition temperature of the thermoplastic resin. When the thermoplastic resin contains a plurality of thermoplastic resins, a temperature of the heat treatment is set above the highest glass transition temperature among the thermoplastic resins. When the temperature of the heat treatment is set higher than the glass transition temperature, the thermoplastic resin layers fuse and bond together, or are not formed uniformly on the EWA particles. Hence, the heat treatment is achieved at the temperature above or near the glass transition temperature.

The physical method forms the thermoplastic resin layer on the surface of each EWA particle with any kinds of thermoplastic resins.

Physicochemical Method (a First Method):

In a first and second methods, EWA particles are hydrophobized and added to a polymerizing composition. The polymerizing composition with the EWA particles are suspended in an aqueous liquid, which mainly contains water, to polymerize the polymerizing composition.

The hydrophobization of the EWA particles reduces wettability thereof so that the EWA particles easily enter and remain in the suspended particles of the polymerizing composition.

When the EWA particles are not subjected to hydrophobization in the first and second methods, the EWA particles escape from the suspended particles and disperse in the aqueous liquid, resulting to a low productivity of the EWA material for thermoforming.

The hydrophobization is achieved with a hydrophobizing finishing agent such as silane coupling agent and fatty acid.

The silane coupling agent is, for example, vinyl-ethoxy silane, vinyl-tris (2-methoxysilane) silane, γ-methacryloxypropyl trimethoxysilane, γ-aminopropyl trimethoxysilane, β-(3,4-epoxycyclohexyl) ethyltrimethoxysilane, γ-mercaptopropyltrimethoxysilane, γ-mercaptopropyltrimethoxysilane but is not limited thereto. The weight ratio of the silane coupling agent to the EWA particles is usually 0.1-5 parts, preferably 0.3-1 parts by weight. Other hydrophobization agents such as titanate coupling agent and aluminum coupling agent can also be utilized as required.

A saturated fatty acid and unsaturated fatty acid can be utilized. The fatty acid is, for example, butyl acid, valerianic acid, caproic acid, enanthic acid, caprylic acid, pelargonic acid, capric acid, lauric acid, myristic acid, pentadecyl acid, pulmitic acid, margarine acid, arachic acid, behenic acid, lignoceric acid, linoleic acid, linolenic acid. Preferably, a higher fatty acid, saturated or unsaturated, has a carbon number of 14-24, such as oleic acid and stearic acid. The weight ratio of the fatty acid to the EWA particles is usually 0.5-5 parts, preferably 1-3 parts by weight.

The hydrophobization forms a layer of the hydrophobizing finishing agent on the surfaces of the EWA particles. The hydrophobization includes the following steps. The hydrophobic material is solved into a solvent and the EWA particles are soaked into the solution and stirred with a stirrer or other means such as ball mill, bead mill, mixer, and a combination thereof. When the hydrophobic material is liquid at room temperature, the EWA particles can be soaked thereto.

The hydrophobized EWA particles are added to the polymerizing composition. A stirrer or ultrasonic agitation can be utilized for attaining a better dispersion of the EWA particles.

The polymerizing material is polymerized in the solution with suspension polymerization. The suspension polymerization is common to the first and second methods of the physicochemical method.

An adjustment of content of the hydrophobized EWA particles to the polymerizing composition can control a blending ratio of the EWA particles to the thermoplastic resin in the EWA material for thermoforming.

The polymerizing composition becomes a matrix of the EWA material for thermoforming but may form the matrix with other compatible resin. It is essential that the polymerizing composition is suspended in the aqueous liquid.

The aqueous liquid is water or may contain a component to stabilize the suspended particles. Such component is a dispersion improver, for example, polyvinyl alcohol, polyvinylpyrrolidone, phosphoric salt, and dextrin, and a protection colloid, such as gelatin, calcium carbonate, and barium sulfate, to stabilize the polymer particles.

The polymerization is achieved with the following steps. The polymerizing composition dispersed with the hydrophobized EWA particles is added into the aqueous liquid and the suspended particles of the polymerizing composition are usually stirred to avoid deposition at a suitable temperature for polymerization. In the first physicochemical method, the particle diameter of the suspended particles of the polymerizing composition is adjusted during suspension after the polymerizing composition is added to the aqueous liquid. The addition of the polymerizing composition to the aqueous liquid does not request any specified method. The polymerizing composition can be poured into the aqueous liquid or vice versa.

The polymerizable thermoplastic resin is vinyl acetate resin, styrene resin, methacrylic resin, and vinyl chloride resin. Methacrylic resin such as polymethylmethacrylate has several features for a suitable thermoplastic resin. The features are fast polymerization to be utilized for molding, easy control of the suspended particles to be utilized for the EWA material for thermoforming, high formability at thermoforming, and high resistance for molding.

In the first physicochemical method, the particle diameter of the EWA material for thermoforming is adjusted during suspension of the polymerizing composition in the aqueous liquid. The polymerizing composition is poured into the aqueous liquid. The aqueous liquid is stirred with the stirrer to prevent the suspended particles from depositing. The diameter of the suspended particles is adjusted with an emulsification/dispersion apparatus such as homogenizer, and a microchannel method to finally obtain the resin particles including the EWA particles with a diameter of 0.5-1,0000 μm. The aqueous liquid is stirred until the polymerization terminates in order to avoid the deposition of the suspended particles. When the suspended particles adhere to each other in the aqueous liquid, it is necessary to continue the stirring.

When the polymerization reaches to a specified degree of polymerization, the polymerization is stopped. The resulting particles are cleaned, dried and crushed to separate the particles adhered each other.

One EWA material for thermoforming formed by the first physicochemical method usually includes one to a few thousands of the EWA particles depending on the compounding ratio of the EWA particles to the polymerizing composition, and the particle size of the EWA material for thermoforming. The number of the EWA particles in the EWA material for thermoforming is controlled by adjusting the content of the EWA particles in the polymerizing composition, and the size of the suspended particles.

The first physicochemical method provides a desired mean particle diameter with a narrow distribution of the particle diameters even though the EWA material for thermoforming is very fine.

Physicochemical Method (the Second Method):

In the second method, the particle diameter of the polymerizing composition is adjusted at suspension contrast to the first method in which the particle diameter is adjusted during suspension.

The polymerizing composition dispersed with the hydrophobized EWA particles is intermittently injected or sprayed into the aqueous liquid for polymerization. The intermittent injection can easily control the particle diameter compared to the whole drop to the aqueous liquid.

The diameter of the suspended particles are easily controlled with a size of droplet and a frequency of injection of the polymerizing composition. The method provides a desired particle diameter of the EWA material for thermoforming. When the suspended particles adhere to each other and the particle size becomes larger, the ultrasonic treatment, a change of kind and concentration of dispersion stabilizer and emulsifier, and the stirring condition can adjust the particle diameter.

When the polymerization reaches to a specified degree of polymerization, the suspended particles are cleaned, dried, and crushed as necessary.

The adjustment of content of the EWA particles in the polymerizing composition can control the compounding ratio of the EWA particles to the resin in the EWA material for thermoforming.

One EWA material for thermoforming usually includes one to a few thousands of the EWA particles depending on the compounding ratio of the EWA particles to the polymerizing composition, and the particle size of the EWA material for thermoforming. The number of the EWA particles in the EWA material for thermoforming is controlled by adjusting the content of the EWA particles in the polymerizing composition, and the diameter of the suspended particles.

The second physicochemical method provides a desired mean particle diameter with a narrow distribution of the particle diameters even though the EWA material for thermoforming is very fine.

Physicochemical Method (a Third Method):

In the third method, an EWA particle aggregate is stirred and the polymerizing composition is dropped or sprayed onto the EWA particle aggregate to form the EWA material for thermoforming.

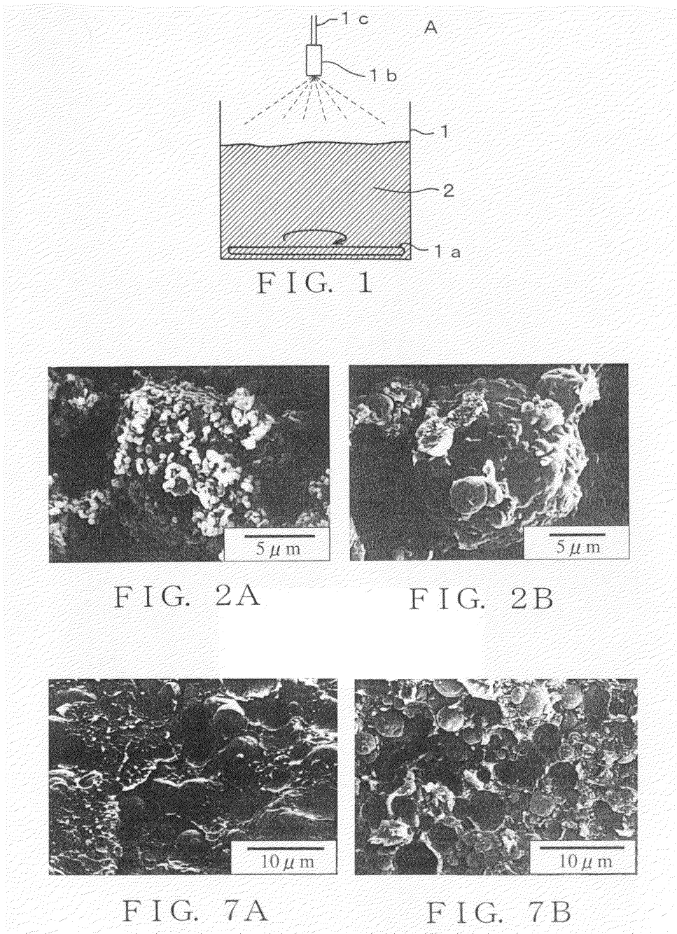

FIG. 1 shows an apparatus A for employing the third method of the present invention. The apparatus A includes a chamber 1 for receiving the EWA particle aggregate 2, a stirrer wing 1a disposed at a bottom of the chamber 1 and driven with a motor (not shown), a spray nozzle 1b for spraying a polymerizing composition onto the EWA particle aggregate 2, and a supply tube 1c for supplying the polymerizing composition.

The EWA particle aggregate 2 in the chamber 1 can be heated with a heater (not shown). The spray nozzle 1b and supply tube 1c are disposed above the chamber 1.

The EWA particle aggregate 2 is stirred with the stirrer wing 1a. The polymerizing composition is sprayed through the spray nozzle 1b and adhered to surfaces of the EWA particle aggregate 2.

The EWA particles are heated with the heater to promote the polymerization of the polymerizing composition so as to form the thermoplastic resin layer on the surfaces of the EWA particles.

The polymerizing composition to be supplied to the EWA particles can be preliminarily heated to a degree that the polymerization does not start. When the polymerization starts prior to spraying, the polymerizing composition becomes viscous and the spray nozzle 1b is subjected to high pressure or is clogged.

The third physicochemical method can utilize the same polymerizing composition as the first physicochemical method but does not employ the suspension polymerization such as the first and second methods so that a water soluble polymerizing composition can be utilized.

The amount of the polymerizing composition sprayed or dropped onto the EWA particle aggregate through the spray nozzle can be controlled with air pressure. Accordingly, the compounding ratio of the EWA particles to the thermoplastic resin in the EWA material for thermoforming is controlled.

The polymerizing composition can be dropped through a narrow tube in place of the spray nozzle 1b. The spray nozzle 1b is selected for adapting to the size of the chamber 1 to obtain the homogeneous EWA material for thermoforming.

When the polymerization reaches to a specified degree of polymerization, the polymerization is stopped and the EWA particle aggregate is washed, dried, and crushed if necessary.

The third physicochemical method provides a large volume fraction of the EWA particles to the EWA material for thermoforming.

Physicochemical Method (a Fourth Method):

The fourth method utilizes Agglomaster of HOSOKAWAMICRON CORPORATION or other similar apparatus, which stirs the EWA particle aggregate with a pulsejet dispersion so as to improve the stirring capacity more than the third method. The polymerization is performed with a wet or dry method. In the wet method, the polymerizing composition covering the EWA particles is poured into an aqueous liquid and polymerized under warming. In the dry method, the polymerizing composition covering the EWA particles is stirred under heating.

Since the fourth physicochemical method utilizes the pulsejet dispersion having a high stirring capacity compared to the third physicochemical method, an agglomeration (secondary particle) of the particles is remarkably suppressed so that the molded EWA body has a uniform distribution of the EWA particles.

Although the present invention discloses the embodiments of each physical and physicochemical method, the combination thereof is within the scope of the invention.

The EWA material for thermoforming produced with the physical and physicochemical methods is heat formed with a suitable method. The molded EWA body can be directly formed from the EWA material for thermoforming or formed with a pellet thereof, or an intermediate EWA body, manufactured with a extrusion molding. The intermediate EWA body such as a sheet film can be utilized for a vacuum molding.

The EWA material for thermoforming of the present invention provides the molded EWA body having the uniform distribution of the EWA particles. The molded EWA body has a high insulation and high EWA property. The EWA property of the molded EWA body is well estimated with the simulation so that the test production is unnecessary or considerably simplified resulting in the reduction of cost and labor hour.

An adjustment of thickness of the molded EWA body can control the EWA performance in the range of 1.7-13 GHz. The molded EWA body can include the high content of the EWA particles so that a desired characteristic is easily obtained with forming.

The uniform distribution of the EWA particles provides superior mechanical property such as high tensile and bending strength even the high volume fraction of the EWA particles.

### EXAMPLES

Embodiments of an electromagnetic wave absorption (EWA) material for thermoforming of the present invention is described in detail in the following.

EWA Particle:

EWA particles (core material) utilized are carbonyl iron (R1470 of TODA KOGYO CORPORATION) and Mn—Zn ferrite (KNS415 of TODA KOGYO CORPORATION).

Mean diameters of grains of the carbonyl iron and Mn—Zn ferrite (hereinafter called to ferrite) are 8.6 μn and 1.7 μm, respectively.

### Example 1

### Physical Method (Hybridization)

Surfaces of the EWA particles are adhered with polymethylmethacrylate particles (PMMA: MP1000 of SOGO KAGAKU, a mean diameter is 0.4 μm, softening temperature is about 128° C., higher than glass transition temperature) with a hybridizer (NHS-O of NARA MACHINERY CO., LTD.) under 10,000 rpm at room temperature for 5 min so as to have a volume ratio 1:1 of the EWA particle to the resin.

The hybridized particles are heat treated in an electric furnace at a temperature of 160° C. for 2 hours so that the EWA particles are covered with the PMMA resin layers having smooth surfaces. During the heat treatment, the hybridized particles are continuously rotated in the electric furnace to prevent the hybridized particles from adhering to each other.

FIG. 2A shows a scanning electron microscope photograph of a hybridized particle of carbonyl iron prior to the heat treatment. FIG. 2B shows a scanning electron microscope photograph of the hybridized particle (an EWA material for thermoforming) after the heat treatment. The photographs clearly show that the PMMA particles adhere to the surface of the carbonyl iron with the hybridizer and cover the surface thereof with the heat treatment.

The EWA material for thermoforming is hot pressed at a temperature of 160° C. under a pressure of 100 kPa to form a molded EWA body having a thickness of 5 mm. The same procedure and shape are utilized for evaluating performances of other molded EWA bodies.

The EWA performance of the molded EWA body is evaluated with a network analyzer (HP8719D of Hewlett-Packard Development Company, L.P.) and a software (HP85071B of the same) using S-parameter method with respect to an absorption factor in a direction of thickness.

The EWA material for thermoforming having the volume ratio 1:1 of the carbonyl iron to the PMMA is molded with a different thickness t of 2.5-4.8 μm.

Material constants (complex permittivity and permeability) of the molded EWA body having a thickness t of 4.87 mm are measured. Minimum peak values at reflection losses of a thickness of 2-7 mm in a frequency of 0.05-13.5 GHz are simulated based on the result of the thickness of 4.87 mm.

The simulation is based on descriptions of “2. Experimental procedure (paragraph 2, Complex permeability . . . ) of Complex permeability and electromagnetic wave absorption properties of amorphous alloy-epoxy composites” in Journal of Non-Crystalline Solids, vol. 351 (2005) p. 75-83, and of “2. Experimental (paragraph 2, The scattering parameters . . . ) of A GHz range electromagnetic wave absorber with wide bandwidth made of FeCo/Y₂O₃ nanocomposites” in Journal of Magnetism and Magnetic Materials, vol. 271 (2004) L147-L152.

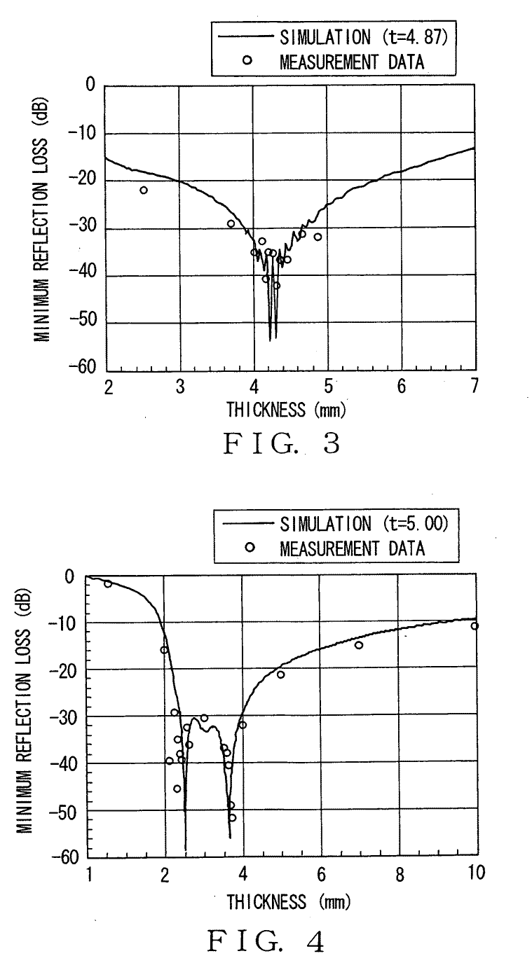

FIG. 3 shows minimum reflection losses (peak values of the frequency of 0.05-13.5 GHz) for the plurality of molded EWA bodies having the thickness t of 2.5-4.8 mm, denoted as circles.

FIG. 3 shows that the molded EWA bodies of a thickness 2.5-4.8 mm have a minimum reflection loss below −20 dB and the molded EWA bodies of a thickness 4-4.8 mm have a minimum reflection loss below −30 dB.

FIG. 3 shows a good agreement between the measurement results of the minimum reflection loss of the molded EWA bodies and the result of the simulation. This means that the molded EWA bodies formed from the EWA material for thermoforming have a uniform EWA and electrical properties.

The carbonyl iron and ferrite are mixed together with a volume ratio of 1:1. The EWA particles and PMMA particles are mixed together with a volume ratio of 50:50 to form the EWA material for thermoforming similar to the above described. The molded EWA bodies hot pressed have a thickness t of 1.3-10 mm.

The material constants (complex permittivity and permeability) of a molded EWA body of a thickness t of 5 mm are measured. Minimum reflection losses of the thickness of 1-10 mm are simulated based on the measurement result of the thickness of 5 mm.

FIG. 4 shows the minimum reflection losses (peak values in the frequency of 0.05-13.5 GHz) for the plurality of the molded EWA bodies of the thickness t of 1.3-10 mm, denoted as circles.

FIG. 4 shows that the molded EWA bodies with a thickness of 2-5 mm have a minimum reflection loss below −20 dB and the molded EWA bodies with a thickness of 2.3-4.0 mm have a minimum reflection loss of below −30 dB.

FIGS. 3 and 4 show good agreements between the measurement results of the minimum reflection loss of the molded EWA bodies and the results of the simulation. This means that the molded EWA bodies formed from the EWA material for thermoforming have the uniform EWA and electrical properties.

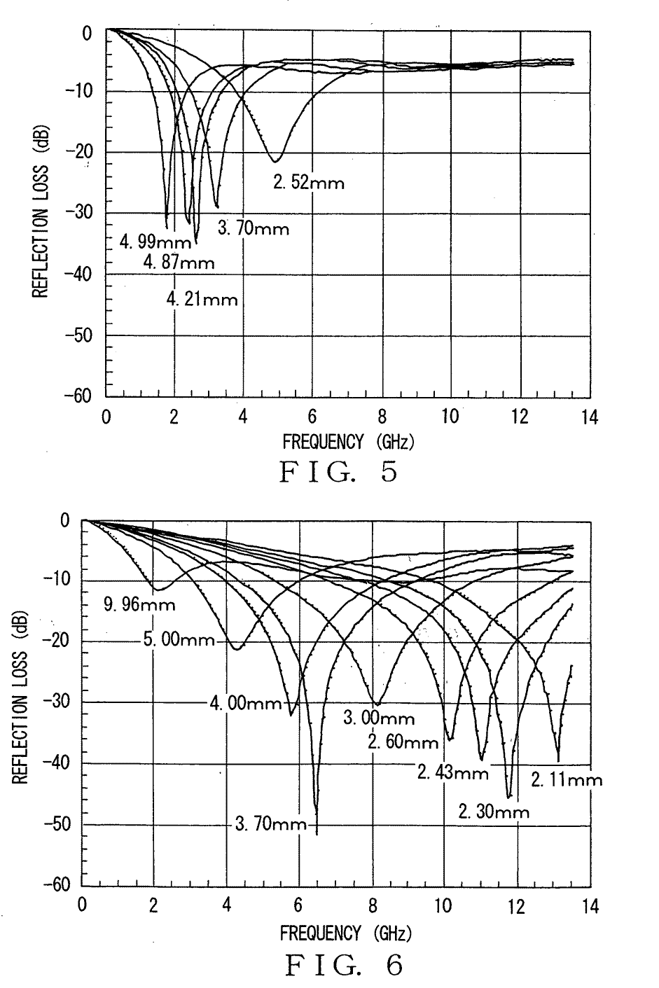

The carbonyl iron particles are mixed with the PMMA particle with a volume ratio of 50:50 to form the EWA material for thermoforming. Several thickness of the molded EWA bodies are prepared and measured with respect to the reflection losses at 0.2-13.5 GHz as shown in FIG. 5.

FIG. 5 shows that the molded EWA bodies with a thickness of at most 5 mm have reflection loss peaks below −20 dB in the frequency of 1.7-5 GHz and the reflection loss peaks below −30 dB in the frequency range of 1.7-2.7 GHz along a direction of the thickness.

The carbonyl iron and ferrite are mixed together with a volume ratio of 1:1. The EWA particles and PMMA particles are mixed together with each volume fraction of 50% to form the EWA material for thermoforming. The molded EWA bodies hot pressed are measured for the reflection losses in the frequency of 0.05-13.5 GHz as shown in FIG. 6.

FIG. 6 shows that the molded EWA bodies of a thickness of 2.11-5 mm have reflection loss peaks below −20 dB in the frequency of 4-13 GHz and the reflection loss peaks below −30 dB in the frequency range of 5.8-13 GHz along a direction of the thickness.

### Example 2

### Physical Method (Mechanofusion)

The PMMA particles of a mean diameter of 0.4 μm are adhered to the surfaces of the above EWA particles with mechanical energy of a mechanofusion system (AM-15F of HOSOKAWAMICRON CORPORATION). The volume ratio of the EWA particles to the thermoplastic resin is about 1:1. The resultant particles are heat treated at 160° C. for 2 hours similar to the heat treatment of the hybridization method to form the flat surfaces of the PMMA resin layers adhering to the EWA particles.

The molded EWA bodies are measured about the EWA. The results show that the molded EWA bodies with a thickness of at most 5 mm have reflection loss peaks below −20 dB in the frequency of 1.7-13 GHz and the reflection loss peaks below −30 dB in the frequency range of 6-13 GHz along a direction of the thickness.

First Physicochemical Method:

Hydrophobization; The ferrite 100 g is added to a solution of stearic acid 1 g and isopropyl alcohol 100 g and the solution is stirred with a ball mill with a rotation of 200 rpm for 30 min. Then the isopropyl alcohol is vaporized and the ferrite is crushed with the ball mill (200 rpm) and shifted with a mesh of 150 μm to form the hydrophobized ferrite particles. Foreign materials on the mesh are removed.

Addition to suspension polymerization; PMMA is utilized for a polymerizing composition.

The polymerizing composition contains 9.5 g of methyl methacrylate (MMA) as a monomer, 0.5 g of ethyleneglycol dimethacrylate (EGDMA) as a cross-linking agent, a mixture of 0.05 g of benzoyl peroxide (BPO) and 0.05 g of lauryl peroxide as a polymerization initiator. The hydrophobized carbonyl iron 30 g or ferrite 30 g is added to the polymerizing composition and stirred. Then an ultrasonic process is carried out to obtain uniform dispersion. The above step provides an EWA material for thermoforming containing the polymerizing composition and the EWA particles with the ratio of 1:1.

The polymerizing composition containing the uniform distribution of the hydrophobized EWA particles is poured into 150 g of ion-exchange water containing 1 g of polyvinyl alcohol as a polymer dispersion stabilizer and stirred at a temperature of 70° C. for 120 min for polymerization.

During the suspension polymerization, a homogenizer (T. K. AUTO HOMOMIXER of PRIMIX Corporation) is utilized so as that the EWA material for thermoforming has a mean particle diameter of about 10 μm.

The EWA material for thermoforming polymerized is washed with ethanol and vacuum filtered and dried at 70° C. for 120 min and crushed with a ball mill (200 rpm, 40 min) and shifted with a mesh (150 μm) to remove foreign and defective substances.

The molded EWA bodies prepared with the first physicochemical method are measured about the EWA. The results show that the molded EWA bodies with a thickness of at most 5 mm have reflection loss peaks below −20 dB in the frequency of 1.7-13 GHz and the reflection loss peaks below −30 dB in the frequency range of 6-13 GHz along a direction of the thickness.

FIG. 7A shows a scanning electron microscopy (SEM) image of a surface of the molded EWA body (4.1 mm thick) including the EWA particles of carbonyl iron. FIG. 7B shows a SEM image of a fracture surface of the molded EWA body. The SEM images verify that the carbonyl iron particles are uniformly distributed in the EWA material for thermoforming and the PMMA as a matrix occupies spaces between the carbonyl iron particles.

A ratio of the content of the carbonyl iron particles to the polymerizing composition is changed 50 parts to 70 parts in volume. The molded EWA body shows an excellent mechanical properties such as tensile and bending strength without difficulty of formability.

Second Physicochemical Method:

The second method is similar to the first method but does not employ the homogenizer for controlling the particle diameter of the emulsion. A polymerizing composition containing uniformly distributed hydrophobized EWA particles is poured into an aqueous liquid through a hollow needle nozzle. The hollow needle nozzle is pressurized with air and controlled by a solenoid valve to intermittently eject the pressurized polymerizing composition to the aqueous liquid for forming suspension. The aqueous liquid is stirred with a stirrer until the polymerization terminates. After polymerization, the aqueous liquid is washed, filtered, dried, crushed and shifted to form the EWA material for thermoforming similar to the first method.

The molded EWA bodies prepared with the second physicochemical method are measured about the EWA. The results show that the molded EWA bodies with a thickness of at most 5 mm have reflection loss peaks below −20 dB in the frequency of 1.7-13 GHz and the reflection loss peaks below −30 dB in the frequency range of 6-13 GHz along a direction of the thickness.

Third Physicochemical Method:

The EWA particles are poured into a cylindrical chamber with a diameter of 20 cm and a depth of 30 cm, to a depth of 3 cm. The chamber has a propeller-like stirrer with a length of 10 cm at a bottom thereof. The EWA particles are stirred at 1,600 rpm at a temperature of 80° C.

The polymerizing composition contains 9.5 g of methyl methacrylate (MMA) as a monomer, 0.5 g of ethyleneglycol dimethacrylate (EGDMA) as a cross-linking agent, a mixture of 0.05 g of benzoyl peroxide (BPO) and 0.05 g of lauryl peroxide as a polymerization initiator. The polymerizing composition is sprayed onto the EWA particles with 10 ml/min. The spray nozzle is placed in the center and about 10 cmm above the chamber.

After spraying, the EWA particles are kept stirring for 120 min for polymerization. After polymerization, washing, filtering, drying, crushing, and shifting are carried out to form the EWA material for thermoforming. The SEM image of the EWA material for thermoforming shows that the EWA particles in the EWA material for thermoforming are separated each other and each covered with the thermoplastic resin layer.

The molded EWA bodies prepared with the third physicochemical method are measured about the EWA. The results show that the molded EWA bodies with a thickness of at most 5 mm have the minimum reflection loss peaks below −20 dB in the frequency of 1.7-13 GHz and the reflection loss peaks below −30 dB in the frequency range of 6-13 GHz along a direction of the thickness.

Fourth Physicochemical Method:

The fourth method utilizes Agglomaster of HOSOKAWAMICRON CORPORATION. The Agglomaster has a stirring portion having pulse-jet dispersion and is operated under a mixer rotation of 500 rpm, a chamber pressure of about 1 kPa, airflow of 50 Pa, room temperature. The 100 g of carbonyl iron is loaded into the chamber. The 9.8 g of polymerizing composition is sprayed onto the EWA particles with 8 ml/min similar to the third method.

The EWA particles surrounded with the polymerizing composition are poured into an aqueous liquid prepared with a mixture of 150 g of ion-exchange water and 1 g of polyvinyl alcohol as a stabilizer of polymer dispersion. The aqueous liquid is stirred with a stirrer at 70° C. for 120 min to prevent the EWA particles from depositing so as to form the EWA material for thermoforming. The SEM image of the EWA material for thermoforming shows that the EWA particles in the EWA material for thermoforming are separated each other and each covered with the thermoplastic resin layer.

The molded EWA bodies prepared with the fourth physicochemical method are measured about the EWA. The results show that the molded EWA bodies of a thickness of at most 5 mm have reflection loss peaks below −20 dB in the frequency of 1.7-13 GHz and the reflection loss peaks below −30 dB in the frequency range of 6-13 GHz along a direction of the thickness.

### INDUSTRIAL APPLICABILITY

The EWA material for thermoforming of the present invention can form the molded EWA body having the EWA particles distributed with a very short distance between the EWA particles, without any additions. The molded EWA body has a high EWA performance at the frequency range of 2 GHz-13 GHz so that the molded EWA body can be adapted not only to a current third-generation mobile telephone but also a next generation mobile telephone, PHS, wireless LAN, ETC (ITS), satellite broadcast, and architecture for OA.

1. An electromagnetic wave absorption (EWA) material for thermoforming comprising:
an EWA particle; and
a thermoplastic resin layer covering the EWA particle.

2. The EWA material for thermoforming as claimed in claim 1, wherein said EWA particle is adhered at a surface thereof with a thermoplastic resin particle, which has a diameter smaller than that of the EWA particle, and heat treated at a temperature above a glass transition temperature of the thermoplastic resin.

3. The EWA material for thermoforming as claimed in claim 1, wherein said EWA particle is hydrophobized and added to a polymerizing composition, and the resulting particle is suspended in an aqueous liquid for polymerization reaction.

4. The EWA material for thermoforming as claimed in claim 3, wherein said EWA particle is hydrophobized with a hydrophobizing finishing agent.

5. The EWA material for thermoforming as claimed in claim 3, wherein a diameter of the suspended particle is adjusted during suspension.

6. The EWA material for thermoforming as claimed in claim 3, wherein said diameter of the suspended particle is adjusted when the resulting particle is poured into the aqueous liquid.

7. The EWA material for thermoforming as claimed in claim 1, wherein said polymerizing composition is poured or sprayed onto an aggregate of the EWA particles while the aggregate is stirred.

8. The EWA material for thermoforming as claimed in claim 1, wherein a molded EWA body with a thickness of at most 5 mm has a reflection loss peak in the frequency of 1.7-13 GHz and the minimum reflection loss of below −20 dB along a direction of the thickness.

9. The EWA material for thermoforming as claimed in claim 1, wherein said molded EWA body with the thickness of at most 5 mm has the reflection loss peak in the frequency of 1.7-3 GHz and/or 6-13 GHz and the minimum reflection loss of below −30 dB along the direction of the thickness.

10. An intermediate EWA body formed with said EWA material for thermoforming as claimed in claim 1.

11. A product having the molded EWA body formed with said EWA material for thermoforming as claimed in claim 1.
